(19) United States
(12) Patent Application Publication
(10) Pub. No.: US 2004/0211807 A1
(43) Pub. Date: Oct. 28, 2004

(54) Tear-off device for continuous materials

(75) Inventors: Wilfried Kolbe, Gulzow (DE); Reinhold Hindemith, Ottersweier (DE); Andreas Kuckelmann, Ibbenburen (DE); Wolfgang Brusdeilins, Bielefeld (DE)

Correspondence Address: RICHARD M. GOLDBERG, 25 EAST SALEM SREEET, SUITE 419, HACKENSACK, NJ, 07601, US

(73) Assignee: Maschinenbau Wilhelm Kochsiek GmbH, Leopoldshohe (DE)

(21) Appl. No.: 10/820,258

(22) Filed: Apr. 8, 2004

(30) Foreign Application Priority Data
Apr. 16, 2003 (EP) 03 008 666.6

(51) Int. Cl. B26F 3/00

(52) U.S. Cl. 225/100

(57) ABSTRACT

Tear-off device for sections (48) of a continuous sheet (18) with a pullout mechanism (10) for the transport of the continuous material (18) and with a tear-off mechanism (12), which has at least two pressure-applying elements (26; 56), which are disposed on opposite sides of the continuous material (18) and of which at least one can be engaged against the continuous material (18) by means of a positioning device, with the engagable pressure-applying elements (26; 56) being constructed as eccentric rollers and can be driven individually or jointly.

The invention relates to a tear-off device for sections of a continuous material, with a pullout mechanism and a tearing-off mechanism of the introductory portion of claim 1.

Such tear-off devices are used, for example, in tube machines as part of a bag line, in order to sever a continuous tube at perforated sites into tube sections. The continuous tube usually is transported by a pullout mechanism between mutually opposite, endless conveyor belts and supplied to the tear-off mechanism.

The DE 44 40 660 discloses a tear-off device for tube sections. On both sides of the continuous tube, the tear-off mechanism of this device has mutually opposite pressure-applying rollers, each of which is mounted on pivoted arms. The conveyor belts of the tear-off mechanism initially do not engage the continuous tube. By pivoting the pivoted arms towards one another, the mutually opposite pressure-applying rollers are engaged against the conveyor belts and against the continuous tube between these belts. Since the speed of the conveyor belts of the tear-off mechanism is higher than that of the conveyor belts of the pullout mechanism, a section of the continuous tube is torn off at a prepared, perforated site.

The EP 0 227 896 discloses a different tear-off device for tube sections, for which three pressure-applying rollers are mounted on one side of the conveyor belts in the tear-off mechanism so that, with the help of an eccentric disk, they can be pushed jointly against opposite pressure-applying rollers.

The DE 41 13 792 discloses a tear-off device, which differs from the aforementioned devices particularly owing to the fact that the pressure-applying rollers are mounted displaceably on either side of the conveyor belts and can be moved synchronously with coupling linkages.

It is an object of the invention to provide a tear-off device of the type named above, the tear-off mechanism of which has a simpler and more solid construction of the positioning device.

Starting out from a tear-off device of the introductory portion of claim 1, for which at least one pressure-applying element can be engaged by means of a positioning device, this objective is accomplished pursuant to the invention owing to the fact that the engagable pressure-applying elements are constructed as eccentric rollers and can be rotated individually or jointly.

It is an advantage of such a construction that the engagement of a pressure-applying element can take place by means of a rotational movement. Such a rotational movement requires only a simple mechanical system and the mounting of the rotating parts can be carried out very robustly.

Preferred embodiments of the invention arise out of the dependent claims.

In a first embodiment, the adjustable pressure-applying elements have internal eccentrics, which can be rotated and on which pressure-applying rollers are mounted rotatably. At least one pressure-applying roller, located on a first side of the continuous material, is engagable. By means of a rotational movement, the pressure-applying roller, mounted on the internal eccentric, can be positioned in contact with or withdrawn from the opposite pressure-applying element and the continuous material located in between. Alternatively, two opposite pressure-applying rollers can be engaged against one another.

In a second embodiment, the adjustable pressure-applying elements have cams, which can be positioned against the continuous material. The cams may have the shape of roller segments. In the case of this embodiment, the pressure-applying elements are rotated at the start of a tear-off process so that the cams face the continuous material or the conveyor belts, so that they engage the continuous material. During the time, in which the pressure-applying elements are engaged, they can continue to be driven or run along freely with any conveyor belts.

For both embodiments, the positioning device preferably has at least one motor, by means of which the pressure-applying elements can be rotated. One of the advantages of such an arrangement is the fact that, in contrast to conventional tear-off devices, a rigid coupling of the engagement process to the transport of the continuous material can be omitted, so that a greater variability is attained. When a pressure-applying element is engaged by means of a motor, the rotational movement furthermore permits the torque or power of the motor to be converted directly into the contacting pressure of the pressure-applying element. Furthermore, the rotational movement can be carried out very quickly and in a controlled manner.

Furthermore, the positioning device preferably has a control device for temporally controlling the movement of the motor. Contrary to conventional tear-off devices, for which the point in time of the engagement process is fixed by an eccentric disk or a different rigid mechanism, a variable and temporally accurate control of the tear-off process is possible in this manner. For example, the movement of a servomotor can be controlled temporally accurately with a known control device.

Preferably, the control device is a programmable control device, with which the points in time of the engagement and/or withdrawal movements can be adjusted in relation to the transport of the continuous material. This has the advantage that the engagement process can be adapted to different operating conditions and different continuous materials, such as continuous tubes of different tube formats, particularly tube sections of different lengths. Accordingly, when the format of the section is to be changed, it is not necessary to redesign the tear-off device. The accurate adjustment of the operating parameters for the tear-off process furthermore permits the use of higher machine speeds than was previously possible with conventional tear-off devices with a rigidly fixed course of the tear-off process.

In an advantageous design especially of the first embodiment, the positioning device has the at least one motor as well as the control device, and the motor can be driven over a limited traversing distance in opposite directions. The adjusting movements of the motor can be controlled temporally by the control device. If the control device is programmable, the traversing distance of the motor may also be programmable. The engagement and withdrawal of the at least one pressure-applying element is accomplished by the motor carrying out only a slight movement back and forth.

In a different advantageous construction of the first or second embodiment, the at least one motor can be driven with a variable speed in one direction of rotation and the speed of the motor can be varied down to zero. Such a movement of the motor has the advantage that lesser accelerations are required, since there is no reversing operation of the motor.

The two variations of the motor movement mentioned have the advantage that, depending on the embodiment, operating parameters, like the duration of the engagement and/or withdrawal movements of the pressure-applying element, can be set individually.

Preferably, the at least one motor is a servomotor. This is advantageous because a servomotor provides a high torque even at very low speeds or when stopped and can have high dynamics. An accurate control of position can be attained by a control circuit with a position sensor. Instead of a servomotor, a stepper motor or a direct drive can also be provided.

Preferably, the pullout mechanism and the tear-off mechanism each has its own driving mechanism. This enables the transporting speeds to be adapted individually to different types of continuous materials. In particular, the excess speed, by which the transporting speed of the tear-off mechanism exceeds the speed of the pullout mechanism, can be adapted to that required for the tearing-off process of the particular type of continuous material. In conjunction with a variable residence time of the pressure-applying element in the engaged state, the tear-off process can furthermore be adapted to the transporting speed of a subsequent processing device.

Particularly for the tear-off device with a motor rotating in one direction, the positioning device advantageously has at least one displaceable frame, in which one or more of the pressure-applying elements are mounted. The distance between opposite pressure-applying elements can be adjusted by shifting the frame. By these means, as is also attainable, moreover, in the case of an embodiment with a limited traversing distance of the motor by varying the traversing distance, the strength of the pressure-applying process can be adapted very easily to the continuous material. If the elastic properties of the pressure-applying elements, the continuous material and any conveyor belts are known, the contacting pressure can be determined, depending on the embodiment, by varying the traversing distance of the motor or the position of the frame. This is advantageous, since different types of continuous materials can have, for example, different coefficients of friction or require a different force for severing the perforations.

The at least one frame preferably is displaceable by at least one second motor.

In the following, preferred examples of the invention are described in greater detail by means of the drawing, in which

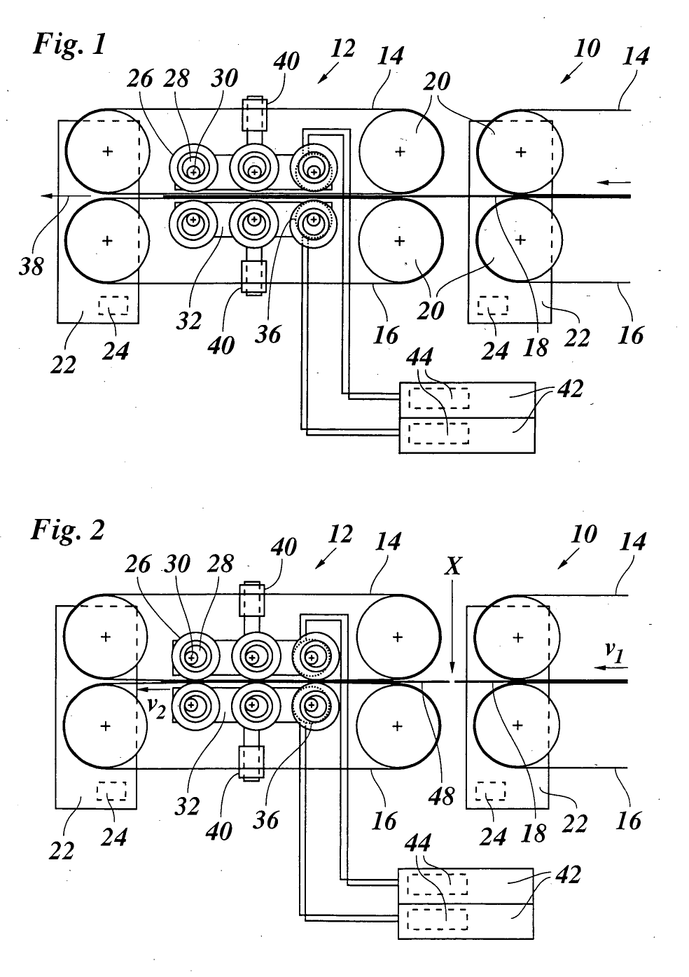

FIG. 1 shows a diagrammatic side view of a tear-off device with engagable pressure-applying rollers, each of which is mounted on an internal eccentric,

FIG. 2 shows the tear-off device of FIG. 1 with the engaged pressure-applying rollers,

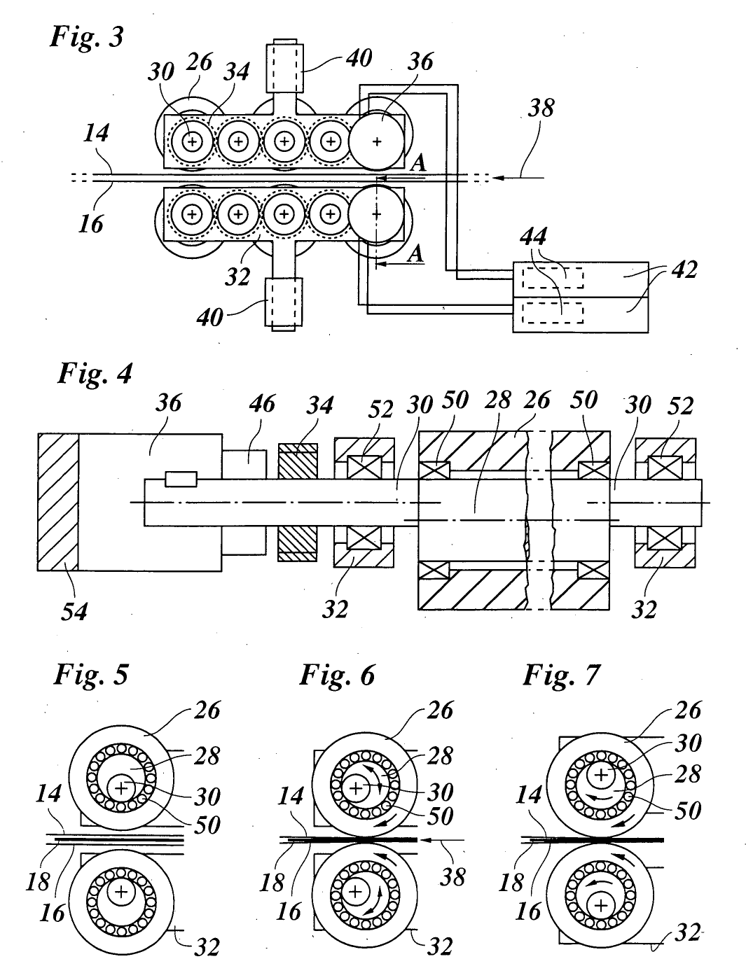

FIG. 3 shows a section of a different diagrammatic side view of the tear-off device of FIG. 1, for which gear wheels are shown, with which the eccentrics are coupled,

FIG. 4 shows a longitudinal section through a pressure-applying roller of FIG. 3 together with the bearing and motor,

FIG. 5 shows a detailed view of two pressure-applying rollers of FIG. 3 in the withdrawn position,

FIG. 6 shows the pressure-applying rollers of FIG. 5 in the engaged position,

FIG. 7 shows the pressure-applying rollers of FIG. 5 in the engaged position, for which the pressure-applying rollers each are deflected the maximum amount vertically and

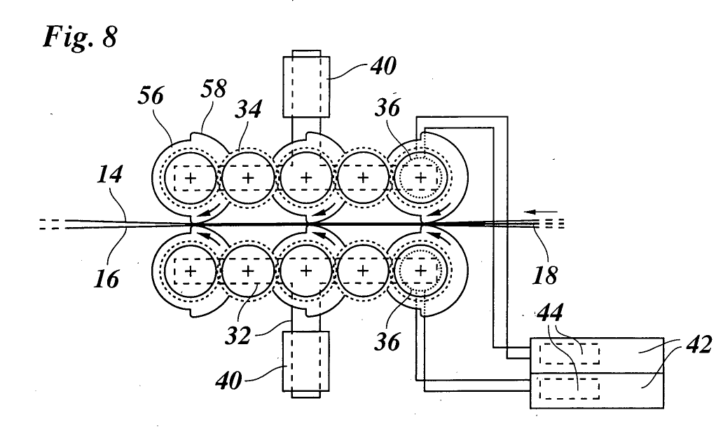

FIG. 8 shows a diagrammatic side view of an embodiment with roller segments.

FIG. 1 shows a first embodiment of a tear-off device with a pullout mechanism 10 and a tear-off mechanism 12. The pullout mechanism 10 and the tear-off mechanism 12 each have upper 14 and lower 16 endless conveyer belts. A continuous material 18 is transported between the conveyor belts 14 and 16. The conveyor belts 14 and 16 run on pulleys 20 and are driven by driving mechanisms 22 with driving mechanism control devices 24. On the upper side of the continuous material 18, the tear-off mechanism 12 has three upper pressure-applying rollers 26, opposite to which there are three lower pressure-applying rollers 26 on the lower side of the continuous sheet 18.

The pressure-applying rollers 26 are each mounted rotatably on roll axes 28, which are mounted over eccentrically applied drive axes 30 in a frame 32. By means of a rotational movement of the appropriate drive axes 30, the roll axes 28 with the pressure-applying rollers 26 can be pivoted about the respective drive axes 30. The upper and lower drive axes 30 each are power coupled over gear wheels 34 (FIG. 3) and are driven by servomotors 36.

The continuous material 18 is moved in one transporting direction 38, which is indicated by an arrow, between the conveyor belts 14 and 16 of the tear-off mechanism 12. At the same time, in the position of the pressure-applying rollers 26 shown in FIG. 1, the conveyor belts 14 and 16 do not engage the continuous material 18, so that the transporting speed of the continuous material 18 is determined by the conveyor belts 14 and 16 of the pullout mechanism 10. The frames 32, in which the drive axes 30 are mounted, can be shifted by second motors 40 essentially perpendicularly to the continuous sheet 18. The distance of the frames 32 from one another can be adjusted selectively by the position of the second motors 40. The motors 40 may, for example, be linear motors.

The position of the servomotors 36 can be controlled selectively and temporally with electronic control devices 42. The control devices 42 may, for example, be memory-programmable control devices. Control electronics 44 of a control circuit of the servomotor 36 are integrated in each control device 42. The control circuit has a position sensor 46 (FIG. 4), which is disposed at the servomotor 36 or integrated there and recognizes the position of the servomotor 36. As the traversing distance and the temporal control of the servomotor 36 can be programmed by the control device 42, the respective, present, nominal position of the servomotor 36 is controlled by control electronics 44 by means of the position sensor 46.

The control devices 42 and the driving mechanism control devices 24, which may, in an appropriate manner, have control circuits with position sensors, interact during the operational control of the tear-off device. For example, the points in time of the engagement and withdrawal movements in relation to the transport of the continuous material 18 can be adjusted with the control devices 42.

FIG. 2 shows the tear-off device of FIG. 1, for which the upper and lower pressure-applying rollers 26 are positioned against one another. For this purpose, they are pivoted about their drive axis 30. The continuous material 18, taken hold of by the conveyor belts 14 and 16 of the tear-off mechanism 12 between the pressure-applying rollers 26, is severed at a perforated place marked with an arrow X because the speed v₂ of the tear-off mechanism 12 is higher than that v₁ of the pull-out mechanism 10. A section 48 of material is severed and removed from the rest of the continuous material 18 during the further transport. Different transporting speeds v₁ and v₂ can be specified over the driving mechanisms 22 independently of one another as required.

FIG. 3 shows an enlarged section of the tear-off mechanism 12 of FIG. 1. The gear wheels 34, with which the drive axes 30 of the upper and lower pressure-applying rollers 26 are coupled, are shown here. In FIG. 3, at the upper and lower frames 32, in each case the right gear wheel 34 is concealed by the servomotor 36. The servomotors 36 drive the drive axes 30 of the upper or lower pressure-applying rollers 26. Instead of the gear wheels 34, cogged belts or other means, for example, may also be provided for the power coupling of the drive axes 30.

FIG. 4 shows a cross section through a lower pressure-applying roller 26 and the associated servomotor 36 of FIG. 3, corresponding to the plane A marked in FIG. 3. The pressure-applying roller 26 is mounted rotatably with fitted bearings 50 on the roll axis 28. At the ends of the roll axis 28, a part of the drive axis 30 is fastened eccentrically. Alternatively, the roll axis 28 and the drive axis 30 may also be produced in one piece. The drive axis 30 is mounted in the frame 32, so that it can rotate in bearings 52. The servomotor 36, which is held at a plate 54, which is not shown in FIG. 3, drives the drive axis 30. The position sensor 46 is disposed at the servomotor 36.

The gear wheel 34, with which the power of the servomotor 36 is transferred to the other drive axes 30 of the lower pressure-applying rollers 26, is fastened on the drive axis 30. However, the arrangement of the elements described at the roll axes 28 and the drive axes 30 represents only an example.

The roll axis 28 is pivoted about the drive axis 30 by means of a rotational movement of the latter. The pressure-applying roller 26, mounted rotatably on the roll axis 28, can thus be engaged against the opposite pressure-applying roller 26.

FIG. 5 shows a partial section of the tear-off mechanism 12 of FIGS. 1 and 3 with the two pressure-applying rollers 26 at the left in the withdrawn state. The roll axes 28 with the drive axes 30, the bearings 50 of the pressure-applying rollers 26 and the frames 32, as well as the conveyor belts 14 and 16, between which the continuous sheet 18 is located, are shown. In the position of the roll axes 28 shown in FIG. 5, the pressure-applying rollers 26 do not contact the conveyor belts 14 and 16. The distance between a pressure-applying roller 26 and the conveyor belt 14 or 16 passing by may, however, also be so small, that the pressure-applying roller 26 is moved along with the conveyor belt and is rotated about its roll axis 28.

FIG. 6 shows the same view as FIG. 5. However, as in FIG. 2, the pressure-applying rollers 26 are in the engaged position at the conveyor belts 14 and 16. For this purpose, the pressure-applying rollers 26 were swiveled opposite to the transporting direction 38 over opposite rotational movements of the respective drive axes 30. In the position of the roll axes 28, as shown in FIG. 6, the engaged pressure-applying rollers 26 are moved by the conveyor belts 14 or 16 and rotated about their respective roller axis 28. In FIG. 6, the distance between the drive axes 30 is so small, that the pressure-applying rollers 26 collide with one another even before their maximum vertical deflection, so that the drive axes 30 cannot carry out a complete revolution. The pressure-applying roller 26 is therefore withdrawn by moving the servomotor 36 in the opposite direction to the engagement movement.

FIG. 7 shows the pressure-applying rollers 26 also in an engaged position. However, they have been deflected vertically to a maximum extent. This is made possible owing to the fact that the distance between the frames 32 is greater than in FIG. 6. In this way, the servomotor 36 can be operated also with a fixed direction of rotation, since the drive axes 30 can be driven in the same direction for the withdrawal as well as for the engagement. On the one hand, an extremely brief tearing-off process can be achieved in this way, since the servomotor 36 no longer has to be stopped. This may be advantageous, for example, for brittle paper. On the other hand, by having the roll axes 28 remain in the position of FIG. 7 with the pressure-applying rollers 26 engaged, a longer period between the engagement and withdrawal of the pressure-applying rollers 26 can also be achieved.

For the embodiment described, the position of the frames 32, shown in FIG. 7, can be set by the second motors 40. By these means, even if the servomotor 36 is operated with a fixed direction of rotation, an adjustment of the contacting pressure of the pressure-applying rollers 26 is possible, which for the position shown in FIG. 6, can already be attained by way of the servomotor 36 alone. In both cases, knowing the elastic properties of the pressure-applying rollers, of the continuous sheet and of any conveyor belts, the contacting force of the engaged pressure-applying rollers can be determined by varying the traversing distance of the servomotor 36 or the position of the second motor 40.

FIG. 8 shows a second embodiment with pressure-applying elements 56, which have cams in the form of roller segments 58. As in the first embodiment, they are coupled on both sides of the continuous material 18 over gear wheels 34 and mounted rotatably at a frame 32. The pressure-applying elements 56 are driven by the servomotors 36 in the direction of rotation indicated by an arrow. FIG. 8 shows the instant, at which the roller segments 58 are placed against one another and reach engagement with the conveyor belts 14 and 16 as well as with the continuous material 18. They continue to rotate in the engaged state and transport the severed section of the continuous material 18, being driven further or carried along freely by the conveyor belts 14 and 16. In the example shown, the engaged state of the roller segments 58 ends after one revolution of about 180°. The point in time of the next positioning process can be controlled by means of the control device 42 of the servomotors 36.

The frames 32 can be shifted vertically by means of second motors 40. In this way, the contacting pressure of the engaged roller segments 58 can be varied and adapted to different thicknesses of continuous material.

Alternatively to the embodiment described, only the pressure-applying rollers 26 or the roller segments 58 on one side of the continuous material 18 may be engagable or mounted at a movable frame 32.

Alternatively to two individually displaceable frames 32, the frames 32 can also be coupled over a coupling linkage, so that they can be engaged synchronously.

In embodiments described, in each case one servomotor 36 drives the drive axes 30 of the lower and of the upper pressure-applying rollers 26 or the pressure-applying elements 56. Alternatively, it is also conceivable that all drive axes 30 or pressure-applying elements 56 are coupled and driven by one servomotor 36.

In the examples shown, mutually opposite pressure-applying elements are disposed in each case vertically to one another on either side of the continuous material. However, the invention also comprises those arrangements, for which the pressure-applying elements are disposed on both sides of the continuous material, offset relative to one another in the transporting direction, so that, when the pressure-applying elements are engaged, the continuous material passes in corrugated fashion through the tear-off mechanism.

Although the examples described in each case have conveyor belts 14 and 16, it is also possible to do without these, in which case the transport of the continuous material 18 is achieved in a different manner, for example, directly by the pressure-applying elements 56.

What is claimed is:

1. Tear-off device for sections of a continuous material, comprising:
a pullout mechanism for the transport of the continuous material and
a tear-off mechanism, which has at least two pressure-applying elements, which are disposed on opposite sides of the continuous material and a positioning device for engaging at least one said pressure-applying element against the continuous material the engagable pressure-applying elements being constructed as eccentric rollers and being adapted to be driven one of:
individually and
jointly.

2. The tear-off device of claim 1, wherein the engagable pressure-applying elements have internal eccentrics, which are adapted to be rotated and on which the pressure-applying rollers are mounted rotatably.

3. The tear-off device of claim 1, wherein the engagable, pressure-applying elements have cams, which are adapted to be engaged against the continuous material.

4. The tear-off device of claim 3, wherein the cams have the shape of roller segments.

5. The tear-off device of claim 1, wherein the positioning device has at least one motor for driving the pressure-applying elements.

6. The tear-off device of claim 5, wherein the positioning device has a control device for temporal control of movement of the motor.

7. The tear-off device of claim 6, wherein the control device is a programmable control device for adjusting points in time of at least one of engagement withdrawal movements in relation to transport of the continuous material.

8. The tear-off device of claim 6, wherein the at least one motor of the positioning device is adapted to be driven over a limited traversing distance in opposite directions and adjusting movements of the at least one motor are adapted to be controlled temporally by the control device.

9. The tear-off device of claim 5, wherein the at least one motor is adapted to be driven in one direction of rotation with a variable speed.

10. The-tear off device of claim 9, wherein the speed of the at least one motor is adapted to be varied down to zero.

11. The-tear off device of claim 5, wherein the at least one motor is a servomotor.

12. The tear-off device of claim 1, wherein the pullout mechanism and the tear-off mechanism each have their own driving mechanism.

13. The tear-off device of claim 1, wherein the positioning device has at least one displaceable frame, in which at least one pressure-applying element is mounted.

14. The tear-off device of one of the claim 8, wherein the control device is a programmable control device for controlling a traversing distance of the at least one motor.
